(19) United States
(12) Patent Application Publication
(10) Pub. No.: US 2017/0248151 A1
(43) Pub. Date: Aug. 31, 2017

(54) SHRINK DISC CONNECTION FOR SURFACE PUMP THRUST CARRYING SHAFTS

(71) Applicant: GE Oil & Gas Esp, Inc., Oklahoma City, OK (US)

(72) Inventors: Andrew Michael NELSON, Oklahoma City, OK (US); Michael David CAMPBELL, Oklahoma City, OK (US); Johnathan Edward PETERSON, Oklahoma City, OK (US)

(73) Assignee: GE Oil & Gas Esp, Inc., Oklahoma City, OK (US)

(21) Appl. No.: 15/516,526

(22) PCT Filed: Oct. 1, 2014
(86) PCT No.: PCT/US2014/058658

§ 371 Date: Apr. 3, 2017

(51) Int. Cl. F04D 29/044; F04D 29/041; F16D 1/033

(52) U.S. Cl. CPC F04D 29/044; F16D 1/033; F04D 29/041; F04D 1/00

(57) ABSTRACT

A shaft coupling for connecting a first shaft to a second shaft includes a first hub that has a shaft sleeve that fits over a portion of the first shaft. The first hub also includes a connection flange connected to the shaft sleeve. The shaft coupling further includes a compression fitting that fits over the shaft sleeve to apply a compressive force to the shaft sleeve and first shaft. The shaft coupling further includes a second hub that is connected to the second shaft and to the first hub.

### FIELD OF THE INVENTION

This invention relates generally to the field of pumping systems, and more particularly to an apparatus and method for connecting thrust-carrying shafts within a surface pumping system.

### BACKGROUND

Horizontal pumping systems are used in various industries for a variety of purposes. For example, in the oil and gas industry horizontal pumping systems are used to pump fluids, such as water separated from oil, to a remote destination, such as a tank or disposal well. Typically these horizontal pumping systems include a pump, a motor, and a suction housing positioned between the pump and the motor. A thrust chamber is also included between the motor and the suction housing.

Torque from the motor is carried to a thrust chamber shaft that extends through the thrust chamber. The thrust chamber shaft is connected to a stub shaft that extends through the suction housing. In high power applications, a significant amount of torque is transferred from the motor to the thrust chamber shaft and stub shaft. Traditionally, the stub shaft has been connected to the thrust chamber shaft with a simple flange at one end of the stub shaft. The thrust chamber shaft is traditionally large enough to have the flange bolt pattern drilled into one end.

With high thrust systems, however, the diameter of the bolt flange on the stub shaft exceeds the diameter of the thrust chamber shaft. It is impractical or otherwise undesirable to manufacture a thrust chamber shaft that matches the size of the stub shaft. There is, therefore, a need for an improved mechanism for connecting the stub shaft to the thrust chamber shaft.

### SUMMARY OF THE INVENTION

In a preferred embodiment, the present invention includes a shaft coupling for connecting a first shaft to a second shaft. The shaft coupling includes a first hub that has a shaft sleeve that fits over a portion of the first shaft. The first hub also includes a connection flange connected to the shaft sleeve. The shaft coupling also includes a compression fitting that fits over the shaft sleeve to apply a compressive force to the shaft sleeve and first shaft. The shaft coupling further includes a second hub that is connected to the second shaft and to the first hub.

In another embodiment, the present invention includes a horizontal pumping system that has a motor, a pump driven by the motor, and a suction chamber connected to the pump. The suction chamber includes a stub shaft that delivers torque to the pump. The horizontal pumping system further includes a thrust chamber that includes a thrust chamber shaft that delivers torque to the stub shaft.

A shaft coupling connecting the thrust chamber shaft to the stub shaft includes a thrust shaft hub and a compression fitting. The compression fitting is connected to the thrust shaft hub and the thrust shaft hub is connected to both the stub shaft and to the thrust chamber shaft.

In yet another aspect, the preferred embodiments include a shaft coupling for connecting a thrust chamber shaft to a stub shaft. The shaft coupling includes a thrust shaft hub connected to the stub shaft and to the thrust chamber shaft and a compression fitting connected to the thrust shaft hub.

### BRIEF DESCRIPTION OF THE DRAWINGS

FIG. 1 is a side view of a horizontal pumping system constructed in accordance with a presently preferred embodiment.

FIG. 2 is a side cross-sectional view of a portion of the thrust chamber, stub shaft, coupling mechanism, and cartridge seal of the horizontal pumping system of FIG. 1.

FIG. 3 is a perspective view of the thrust chamber shaft.

FIG. 4 is a perspective view of the thrust chamber shaft hub.

FIG. 5 is a perspective view of the stub shaft assembly.

FIG. 6 is a perspective view of a shrink disc constructed in accordance with preferred embodiments.

FIG. 7 is a cross-sectional view of the shrink disc of FIG. 6.

### DETAILED DESCRIPTION OF THE PREFERRED EMBODIMENT

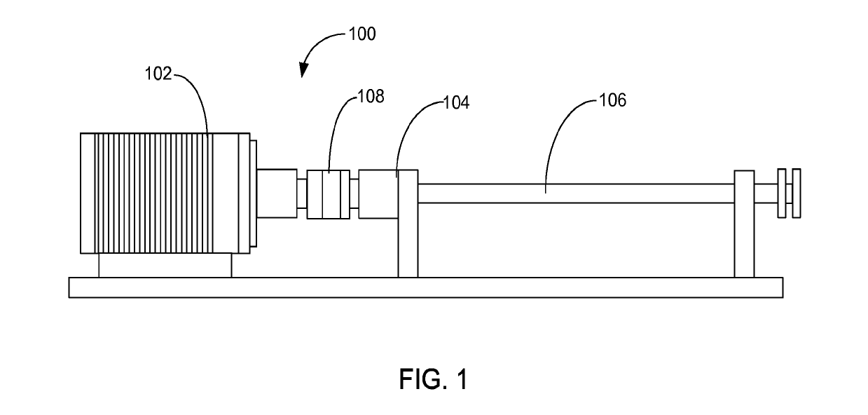

In accordance with a preferred embodiment of the present invention, FIG. 1 shows a side view of a horizontal pumping system 100. The horizontal pumping system 100 includes a motor 102, a suction housing 104, a pump 106 and a thrust chamber 108. The suction housing 104 is connected between the pump 106 and the thrust chamber 108. The thrust chamber 108 is connected between the suction housing 104 and the motor 102. Generally, the motor 102 drives the pump 106 through a series of shafts (not visible in FIG. 1) that extend through the thrust chamber 108 and suction housing 104. Pumped fluids are provided to the suction housing 104 and pressurized by the pump 106. In a preferred embodiment, the pump 106 is a centrifugal pump. In a particularly preferred embodiment, the pump 106 is a multistage centrifugal pump.

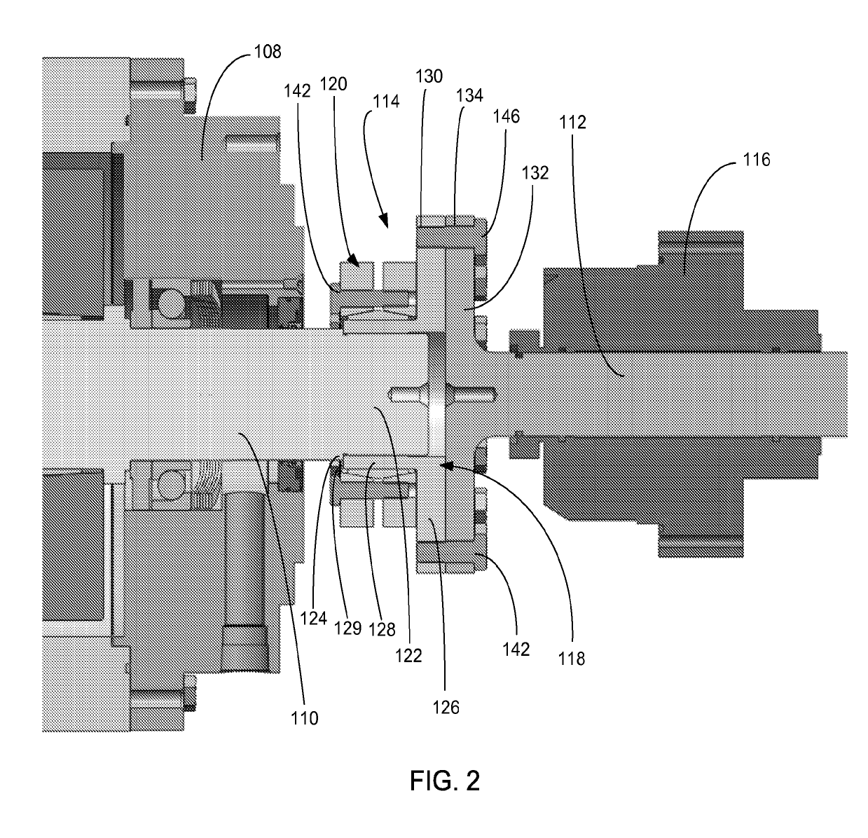

Turning to FIG. 2, shown therein is a side cross-sectional view of a portion of the thrust chamber 108, a portion of a thrust chamber shaft 110, a portion of a stub shaft 112, a shaft coupling 114 and a cartridge seal assembly 116. The shaft coupling 114 includes a thrust shaft hub 118 and a compression fitting 120. It will be noted that cartridge seal assembly 116 is typically located within the suction housing 104. For clarity, the housing of the suction housing 104 has been removed in FIG. 2.

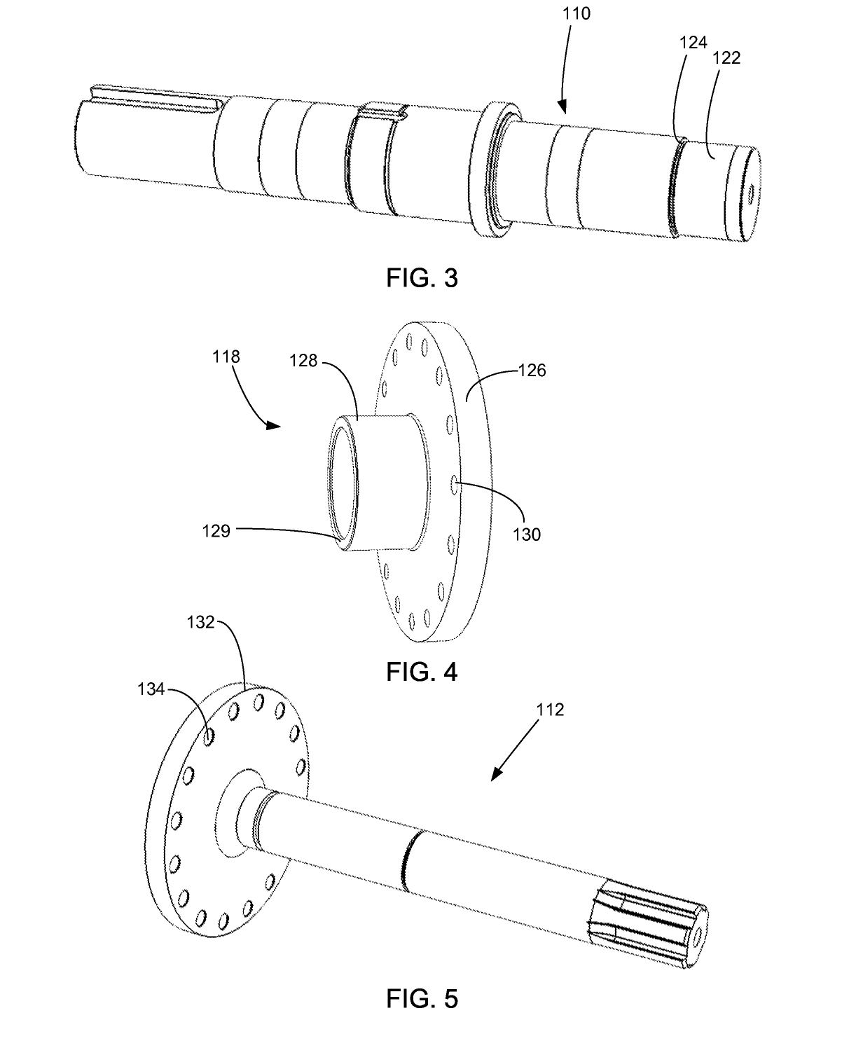

Turning to FIGS. 3 and 4, shown therein are perspective views, respectively, of the thrust chamber shaft 110 and thrust shaft hub 118. The thrust chamber shaft 110 includes a hub portion 122 and a shoulder 124. The thrust shaft hub 118 includes a connection flange 126, a shaft sleeve 128 and an axial face 129 on the distal end of the sleeve 128. In a particularly preferred embodiment, the connection flange 126 and shaft sleeve 128 are manufactured from a unitary piece of material. The thrust shaft hub 118 further includes a plurality of fastener bores 130.

Turning to FIG. 5, shown therein is a perspective view of the stub shaft 112. The stub shaft 112 includes a stub shaft hub 132. The stub shaft hub 132 is preferably manufactured as a separate piece and welded or otherwise secured to the stub shaft 112. The stub shaft hub 132 includes a plurality of fastener bores 134. Because the stub shaft 112 extends into the suction housing 104 and is exposed to pumped fluids, the stub shaft 112 is preferably manufactured from stainless or another corrosion-resistant metal.

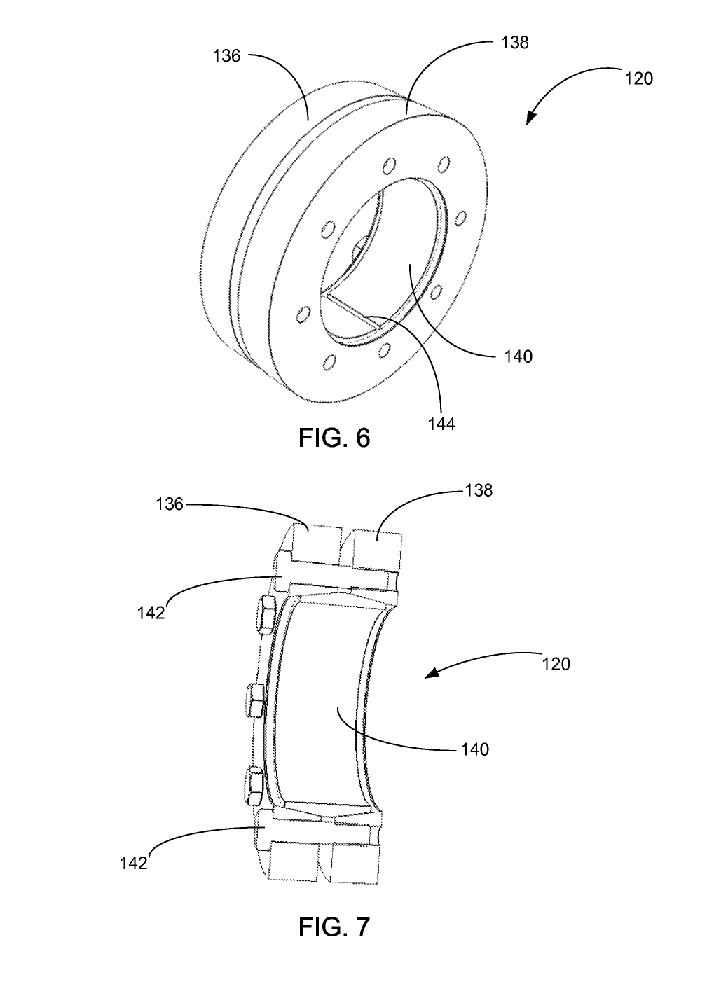

Turning to FIGS. 6 and 7, shown therein are perspective and cross-sectional views, respectively, of the compression fitting 120 of the shaft coupling. The compression fitting 120 is configured to provide an adjustable amount of compression to the thrust shaft hub 118. In a particularly preferred embodiment, the compression fitting 120 is a “shrink disc” coupler that includes a first outer ring 136, a second outer ring 138, an inner ring 140 and a plurality of compression fitting fasteners 142. Tightening the compression fitting fasteners 142 draws the first outer ring 136 together with the second outer ring 138. The tapered configuration of the exterior of the inner ring 140 and the interior of the first outer ring 136 and second outer ring 138 causes the inner ring 140 to reduce in diameter as the first outer ring 136 and second outer ring 138 are approximated. The inner ring 140 may include a channel 144 that facilitates the reduction of the diameter of the inner ring 140. Suitable “shrink disc” couplers are available under the B-LOC brand from Fenner Drives, Inc.

During assembly, the compression fitting 120 is loosened and placed over the shaft sleeve 128 of the thrust shaft hub 118. The thrust shaft hub 118 is then placed over the hub portion 122 of the thrust chamber shaft 110. The thrust shaft hub 118 is the loaded onto the thrust chamber shaft 110 until the shaft sleeve 128 abuts the shoulder 124. In a particularly preferred embodiment, the inner diameter of the shaft sleeve 128 is nominally a slight clearance fit to the outer diameter of the hub portion 122 of the thrust chamber shaft 110. To install the thrust shaft hub 118 onto the thrust chamber shaft 110, an assembly press (not shown) can be threaded onto the end of the thrust chamber shaft 110 and tightened to apply a force against the connection flange 126 of thrust shaft hub 118, bringing the axial face 129 into contact with the shoulder 124 of the thrust chamber shaft 110.

Once the thrust shaft hub 118 has been completely loaded onto the thrust chamber shaft 110, the compression fitting 120 is tightened to lock the thrust shaft hub 118 onto the thrust chamber shaft 110. In a particularly preferred embodiment, the compression fitting 120 is engaged by tightening compression fitting fasteners 142 to approximate the first outer ring 136 and second outer ring 138. As the first outer ring 136 and second outer ring 138 are drawn together, the inner ring 140 contracts and applies a locking compressive force to the shaft sleeve 128 and hub portion 122 of the thrust chamber shaft 110. The assembly press is removed following complete tightening of the compression fitting 120.

Next, the stub shaft 112 is connected to the thrust chamber shaft 110 by connecting the stub shaft hub 132 to the connection flange 126 of the thrust shaft hub 118. Fastener bores 130 are aligned with fastener bores 134 and fasteners 146 are tightened to lock the stub shaft 112 to the thrust chamber shaft 110. In this way, thrust generated by the pump 106 is carried through the stub shaft 112, through the shaft coupling 114 and into the thrust chamber shaft 110 via the shoulder 124. Torque is transferred from the thrust chamber shaft 110 to the stub shaft 112 through the coupling 114. The compression fitting 120 locks the thrust shaft hub 118 to the thrust chamber shaft 110 without the use of a splined or keyed connection between the thrust chamber shaft 110 and the thrust shaft hub 118. The use of the shaft coupling 114 presents a novel and improved way of connecting the stub shaft 112 to the thrust chamber shaft 110 that will find particular utility in high power applications.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention. As an example, the shaft coupling 114 can be used to connect any a first shaft to any corresponding second shaft.

What is claimed is:

1. A horizontal pumping system comprising:
a suction chamber connected, wherein the suction chamber includes a stub shaft;
a thrust chamber, wherein the thrust chamber includes a thrust chamber shaft that delivers torque to the stub shaft; and
a shaft coupling connecting the thrust chamber shaft to the stub shaft, wherein the shaft coupling comprises:
a thrust shaft hub, wherein the thrust shaft hub is connected to the stub shaft and to the thrust chamber shaft; and
a compression fitting, wherein the compression fitting is connected to the thrust shaft hub.

2. The horizontal pumping system of claim 1, wherein the thrust chamber shaft comprises:
a hub portion; and
a shoulder.

3. The horizontal pumping system of claim 2, wherein the thrust shaft hub comprises:
a shaft sleeve, wherein the shaft sleeve fits over the hub portion of the thrust chamber shaft; and
a connection flange connected to the shaft sleeve.

4. The horizontal pumping system of claim 3, wherein the compression fitting surrounds an exterior of the shaft sleeve.

5. The horizontal pumping system of claim 4, wherein the compression fitting applies a compressive force to the shaft sleeve to lock the thrust shaft hub to the thrust chamber shaft.

6. The horizontal pumping system of claim 4, wherein the compression fitting is a shrink disc.

7. The horizontal pumping system of claim 6, wherein the compression fitting comprises:
a first outer ring;
a second outer ring; and
an inner ring, wherein the inner ring is reduced in diameter when the first outer ring and the second outer ring are approximated.

8. The horizontal pumping system of claim 7, wherein the stub shaft includes a stub shaft hub that is attached to the connection flange of the thrust shaft hub.

9. A shaft coupling for connecting a thrust chamber shaft to a stub shaft, wherein the shaft coupling comprises:
a thrust shaft hub, wherein the thrust shaft hub is connected to the stub shaft and to the thrust chamber shaft; and
a compression fitting, wherein the compression fitting is connected to the thrust shaft hub.

10. The shaft coupling of claim 9, wherein the thrust chamber shaft comprises:
a hub portion; and
a shoulder.

11. The shaft coupling of claim 10, wherein the thrust shaft hub comprises:
a shaft sleeve, wherein the shaft sleeve fits over the hub portion of the thrust chamber shaft; and
a connection flange connected to the shaft sleeve.

12. The shaft coupling of claim 11, wherein the compression fitting surrounds an exterior of the shaft sleeve.

13. The shaft coupling of claim 12, wherein the compression fitting applies a compressive force to the shaft sleeve to lock the thrust shaft hub to the thrust chamber shaft.

14. The shaft coupling of claim 13, wherein the compression fitting is a shrink disc.

15. The shaft coupling of claim 13, wherein the compression fitting comprises:
a first outer ring;
a second outer ring; and
an inner ring, wherein the inner ring is reduced in diameter when the first outer ring and the second outer ring are approximated.

16. The shaft coupling of claim 15, wherein the stub shaft includes a stub shaft hub that is attached to the connection flange of the thrust shaft hub.

17. A shaft coupling for connecting a first shaft to a second shaft, wherein the shaft coupling comprises:
a first hub, wherein the first hub comprises:
a shaft sleeve, wherein the shaft sleeve fits over a portion of the first shaft; and
a connection flange connected to the shaft sleeve;
a compression fitting, wherein the compression fitting fits over the shaft sleeve to apply a compressive force to the shaft sleeve and first shaft; and
a second hub, wherein the second hub is connected to the second shaft and to the first hub.

18. The shaft coupling of claim 17, wherein the second hub is non-removably connected to the second shaft.

19. The shaft coupling of claim 19, wherein the first hub is removably connected to the first shaft.

20. The shaft coupling of claim 18, wherein the compression fitting comprises:
a first outer ring;
a second outer ring; and
an inner ring, wherein the inner ring is reduced in diameter when the first outer ring and the second outer ring are approximated.
